(19) United States
(12) Patent Application Publication
(10) Pub. No.: US 2009/0138692 A1
(43) Pub. Date: May 28, 2009

(54) Self describing line cards in network switch

(76) Inventors: Kenneth J. Duda, Menlo Park, CA (US); Hugh W. Holbrook, Palo Alto, CA (US); Lorenz W. Redlefsen, Palo Alto, CA (US)

Correspondence Address: LUMEN PATENT FIRM, 2345 YALE STREET, SECOND FLOOR, PALO ALTO, CA, 94306, US

(21) Appl. No.: 12/291,157

(22) Filed: Nov. 5, 2008

Related U.S. Application Data
(60) Provisional application No. 61/001,959, filed on Nov. 5, 2007.

(51) Int. Cl. G06F 15/177

(52) U.S. Cl. 713/1

(57) ABSTRACT

A network switch device includes a switch chassis, a supervisor mounted in the switch chassis; and a line card mounted in the chassis. The line card has independently addressable line card hardware components, and a line card memory storing a software-readable description of the line card hardware components. The supervisor controller reads the software-readable description of the line card hardware components from the line card, and creates software drivers for the line card hardware components from the software-readable description of the line card hardware components.

### FIELD OF THE INVENTION

The present invention relates generally to computer software and devices. More specifically, it relates to devices and methods for self-describing line cards (or other field-replaceable modules) in network switches and methods for switch operation incorporating such modules.

### BACKGROUND OF THE INVENTION

Existing computer systems, and network switches in particular, have a “new hardware, old software” problem. This is the problem where a new field-replicable unit (such as a line card in a network switch) is developed, and the unit is quite similar to an existing unit, with relatively small differences. The differences may be, for example, the total number of ports, number of ports of different types, the port layout and numbering/labeling scheme, etc.

Historically, new code in the switch is required to handle these differences, forcing users of the new line card to upgrade their switch software. Users would prefer to run exiting software in many cases. Existing systems, however, require software updates to accommodate hardware updates.

### SUMMARY OF THE INVENTION

In one aspect, the invention provides a network switch device comprising:
a) a chassis;
b) a supervisor mounted in the switch chassis; and
c) a line card mounted in the switch chassis;
   wherein the line card comprises:
i) independently addressable line card hardware components, and
ii) a line card memory storing a software-readable description of the line card hardware components;
   wherein the supervisor comprises a system controller that
i) reads the software-readable description of the line card hardware components from the line card, and
ii) creates software drivers for the line card hardware components from the software-readable description of the line card hardware components.

### BRIEF DESCRIPTION OF THE DRAWINGS

FIG. 1 is a block diagram of a switch comprising a chassis, supervisor, and line cards according to an embodiment of the invention.

FIG. 2 is a block diagram of a switch comprising a chassis, supervisor, and line cards according to an embodiment of the invention.

FIG. 3 is a block diagram of a line card comprising a controller, hardware components, and a memory containing descriptions of the hardware components, according to an embodiment of the invention.

FIG. 4 is a flow chart illustrating a method for software driver configuration in a switch according to an embodiment of the invention.

FIG. 5 is a schematic diagram illustrating data elements contained in a software readable description of a field replicable unit such as a line card, according to an embodiment of the invention.

### DETAILED DESCRIPTION

In a preferred embodiment, a network switch hardware component, such as a line card, contains an executable description of itself called the FDL. This executable description creates an object model of the primary components on the line card and how they are interconnected. Switch software traverses the model, configuring drivers accordingly.

In our preferred embodiment, the FDL is written in python and is stored in a serial EEPROM. When the line card is detected, the fdl is read and executed.

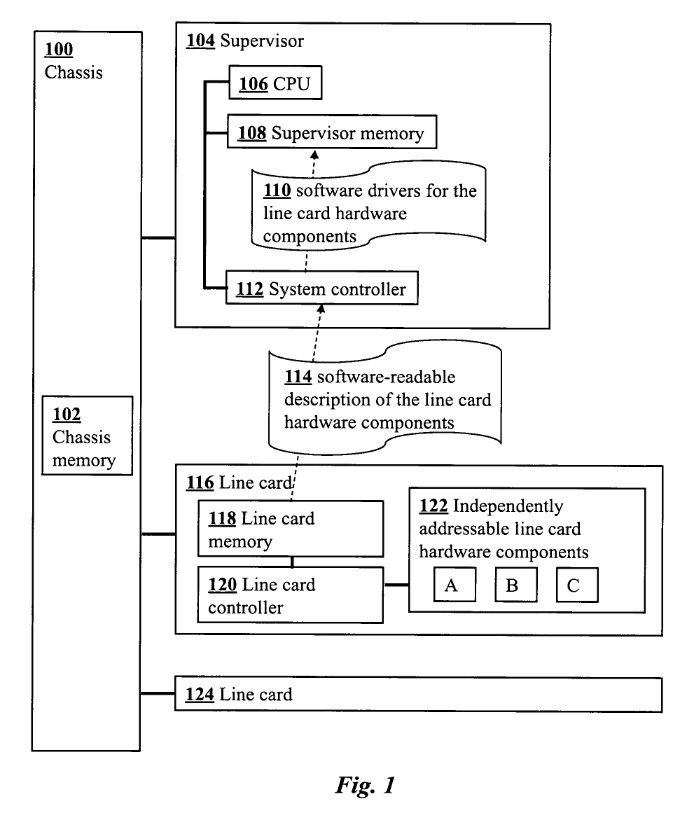

FIG. 1 is a block diagram of a switch according to an embodiment of the invention. The switch includes a chassis 100, supervisor 104, and line cards 116 and 124. Chassis 100 has a memory 102 and is connected to supervisor 104, and line cards 116 and 124. Supervisor 104 includes CPU 106, supervisor memory 108, and system controller 112. Line card 116 contains line card memory 118, line card controller 120, and independently addressable line card hardware components 122 denoted A, B, C. Line card 124 has similar components (not shown). In operation, line card memory 118 contains a software readable description 114 of the line card hardware components 122. This description 114 is sent to system controller 112 in the supervisor 104 as part of the switch initialization process when the switch is powered on. The system controller 112 interprets the description 114 and configures general purpose line card management software to serve as customized software drivers 110 for the line card hardware components 122. These drivers 110 are then stored in the supervisor memory 108 for use during switch operation. In another embodiment the description 114 is read from a memory on the line card by system controller 112 in the supervisor 104, rather than being actively sent to it.

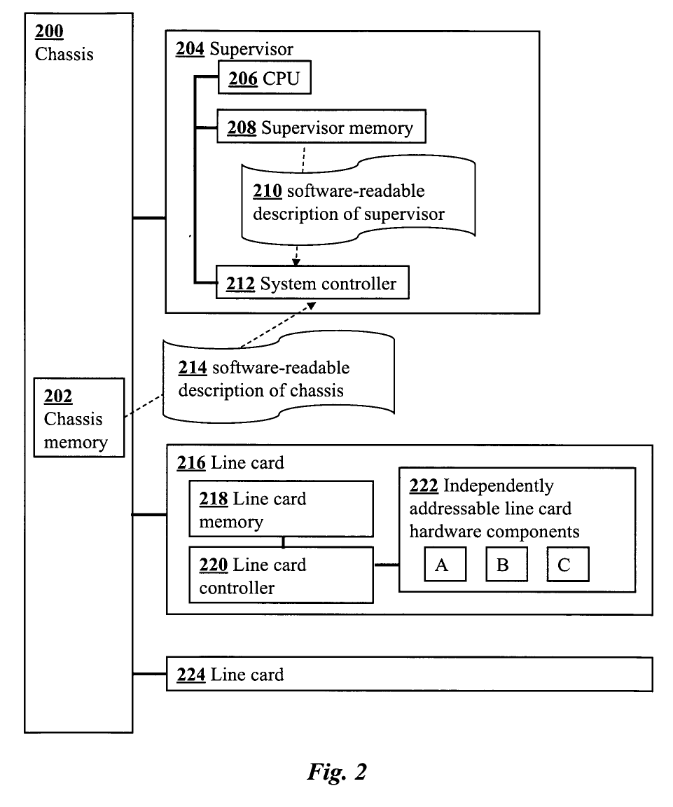

FIG. 2 is a block diagram of a switch illustrating another aspect of the invention. The switch again includes a chassis 200, supervisor 204, and line cards 216 and 224. Chassis 200 has a memory 202 and is connected to supervisor 204, and line cards 216 and 224. Supervisor 204 includes CPU 206, supervisor memory 208, and system controller 212. Line card 216 contains line card memory 218, line card controller 220, and independently addressable line card hardware components 222 denoted A, B, C. Line card 224 has similar components (not shown). In operation, chassis memory 202 contains a software readable description 214 of the chassis hardware attributes. This description 214 is sent to system controller 212 in the supervisor 204 as part of the switch initialization process when the switch is powered on. Similarly, supervisor memory 208 contains a software readable description 210 of supervisor 204. This description 210 is sent to system controller 212 in the supervisor 204 as part of the switch initialization process. In another embodiment the description 214 of the chassis is read from a memory on the chassis by system controller 212 in the supervisor 204, rather than being actively sent to it.

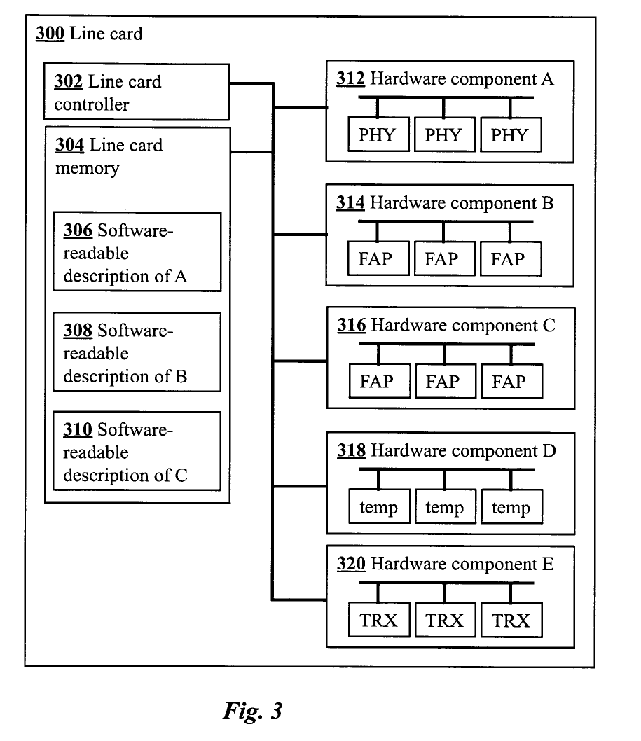

FIG. 3 is a block diagram showing details of a line card 300 according to an embodiment of the invention. The line card 300 includes a controller 302, hardware components 312, 314, 316, 318, 320, and a memory 304 containing descriptions 306, 308, 310 of the hardware components 312, 314, 316, respectively.

FIG. 4 is a flow chart illustrating a method for software driver configuration in a switch according to an embodiment of the invention. In step 400 the system controller detects the line card presence in a chassis slot. It can also detect line card insertion, removal, disabling, or resetting. In step 402 the system controller obtains from each line card a software readable description of the line card's hardware components. The description also includes information regarding how the hardware components are connected to each other within the line card. In step 404 the system controller creates from the software readable description a software model of the line card hardware components present and how they are connected to each other. In step 406 the system controller uses the software model to customize and configure general purpose line card management software to serve as device drivers for the hardware components on the line cards.

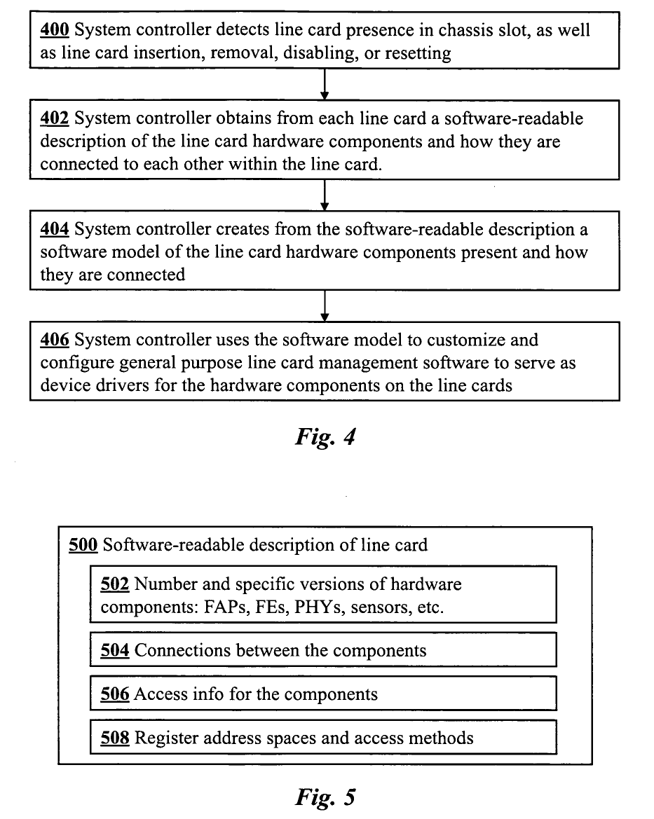

FIG. 5 is a schematic diagram illustrating data elements contained in a software readable description of a field replicable unit such as a line card, according to an embodiment of the invention. The software readable description 500 of a line card contains data element 500 which includes information describing the number and specific versions of line card hardware components such as fabric ASIC (FAP), port ASIC (FE), sensors, and so on. Data element 504 contains information describing the connections between the line card hardware components. Data element 506 contains information describing access information for the line card hardware components. Data element 508 contains information describing register address spaces and access methods for the line card. This line card description 500 may be sent from the line card to the supervisor as described above in relation to FIG. 4 and FIG. 1.

At the end of this description is an example FDL that shows the self-describing nature of the hardware description. It illustrates various novel aspects of this invention, including the fact that the description is executable code that builds a complex object model, the fact that the description can contain pointers from one object in the object model to another object in the object model thereby representing the actual electrical connections between component, the description of the topology of the system management bus (SMBus) on the card.

This representative FDL demonstrates a number of novel aspects of the invention:

1. The fact that the description is executable code that builds a complex object model.
2. A part of the description that contains pointers from one object in the object model to another object in the object model thereby representing the actual electrical connections between component. In the representative example, the traces from the “port asic” to the backplane connector are represented.
3. A representation of how many front panel sockets are on the card, how many Phy chips, and how many PortAsics, including which Phy chip and port the front panel port is connected to, and which Port Asic each phy chip is connected to. These two lines are an example of this also demonstrating the use of pointers in the model:
port.portConnection.associatedEntity=port
port.portConnection.otherEndpoint=phy.macConnection
   4. The description of the topology of the system management bus (SMBus as is commonly known to one skilled in the art) on the card and the components on the system management bus.
   5. The encoding of the temperature threshold values for the temperature sensors on the card.
   6. A map that encodes the recommended fan speed at various measured inlet temperatures.
   7. A representation of the connector pinout for each of the connectors on the card, indicating which components on the card the various connector pins connect to.
   8. A representation of the manufacturer, model, hardware revision and “API” for individual hardware components.
   9. An indication of how external non-software-visible pins on various hardware components are wired, e.g. “p.rxLosPinPolarity=1”.

We conclude with an FDL example, as follows:

1. A network switch device comprising:
a) a chassis;
b) a supervisor mounted in the chassis; and
c) a line card mounted in the chassis;
wherein the line card comprises:
i) independently addressable line card hardware components, and
ii) a line card memory storing a software-readable description of the line card hardware components;
wherein the supervisor comprises a system controller that
i) reads the software-readable description of the line card hardware components from the line card, and
ii) creates software drivers for the line card hardware components from the software-readable description of the line card hardware components.
